(19) United States
(12) Patent Application Publication
(10) Pub. No.: US 2022/0168691 A1
(43) Pub. Date: Jun. 2, 2022

(54) CHIMNEY STARTER AND CATALYST UNIT FOR A CHIMNEY STARTER

(71) Applicant: InoxAir GmbH, Gelsenkirchen (DE)

(72) Inventors: René BRUDER, Gelsenkirchen (DE); Siar KAYA, Dorsten (DE)

(73) Assignee: InoxAir GmbH, Gelsenkirchen (DE)

(21) Appl. No.: 17/437,860

(22) PCT Filed: Mar. 10, 2020
(86) PCT No.: PCT/EP2020/056348

§ 371 Date: Feb. 11, 2022

(30) Foreign Application Priority Data
Mar. 13, 2019 (DE) 10 2019 101 426

(51) Int. Cl. B01D 53/86; A47J 37/07

(52) U.S. Cl. CPC B01D 53/864; A47J 37/079; B01D 2258/0275; B01D 2257/502; B01D 2255/207

(57) ABSTRACT

An ignition chimney (1) for carbonaceous fuel (2) is shown and described, with a housing (3), a lower combustion chamber (4) formed in the housing (3) for easily ignitable igniter (5), with an upper combustion chamber (6) formed in the housing (3) for the carbonaceous fuel (2), wherein, in the ready-for-operation state, the upper combustion chamber (6) is arranged above the lower combustion chamber (4), and the lower combustion chamber (4) and the upper combustion chamber (6) are separated from one another by a gas-permeable separator (7), the upper side (8) of the separator (7), which faces the upper combustion chamber (6), forming a receptacle for the fuel (2), the separator (7) being designed such that the igniter exhaust gases (9) produced in the ignited state of the igniter (5) pass through the separator (7) and impinge on the fuel (2) resting on the separator (7).

The risk of carbon monoxide poisoning by exhaust gases during combustion of the (carbonaceous) fuel is considerably reduced in the ignition chimney in that a catalyst (11) for catalyzing the oxidation of carbon monoxide to carbon dioxide with oxygen is arranged above the receptacle for the fuel (2) in such a way, that the fuel exhaust gases (12) produced in the ignited state of the fuel (2) are at least partially conducted to the catalyst (11) or through the catalyst (11) and at least part of the carbon monoxide present in the fuel exhaust gases (12) is oxidized to carbon dioxide.

The invention relates to an ignition chimney for carbonaceous fuel, with a housing, a lower combustion chamber formed in the housing for easily ignitable igniter, with an upper combustion chamber formed in the housing for the carbonaceous fuel, wherein, in the ready-to-use state, the upper combustion chamber is arranged above the lower combustion chamber and the lower combustion chamber and the upper combustion chamber are separated from one another by a gas-permeable separator, wherein the upper side of the separator facing the upper combustion chamber forms a receptacle for the fuel, wherein the separator is formed such that the igniter exhaust gases produced in the ignited state of the igniter pass through the separator and strike the combustible material resting on the separator. In addition, the invention also relates to a catalyst unit for such an ignition chimney having a catalyst for catalyzing the oxidation of carbon monoxide to carbon dioxide with oxygen.

Ignition chimneys of the type previously described have been known for a long time. They are ignition aids for carbonaceous fuel, usually in the form of charcoal. Typical applications include lighting charcoal for barbecues, but increasingly also charcoal for use with water pipes.

The cold charcoal, which is still to be ignited, is placed in the upper combustion chamber, and the charcoal comes to rest on the separator between the upper and lower combustion chambers. For further use, the igniter is then usually placed on a fire-proof base and ignited there. The ignition chimney is then placed on the igniter in such a way that it is received in the lower combustion chamber and can continue to burn undisturbed. When “above/up” and “below/down” are referred to here, the common understanding is meant, namely that the orientation of the earth's gravitational field, whose force is “down”; thus, the opposite direction is “up”. The hot igniter exhaust gases rise upward in a convective manner, through the gas-permeable separator—for example, a perforated metal sheet—and then flow to the fuel in the upper combustion chamber, which then ignites.

The housing of the ignition chimney is often formed by a metal tube, in which practically only the separator is located. The tube is thus open at the top and bottom, and the upper combustion chamber and the lower combustion chamber are accessible through the openings. In the operational state, the ignition chimney stands with the edge contour of the opening of the lower combustion chamber on a—preferably fire-proof—base. When the fuel in the upper combustion chamber is ignited, it can be removed from the opening in the upper combustion chamber, for example in individual pieces with tongs, but the fuel can also simply be dumped out.

A serious problem arises from the fuel exhaust gases produced by the fuel when ignited. In particular, the carbon monoxide (with the molecular formula CO) contained in the exhaust gases is problematic because it is extremely toxic, but nonetheless imperceptible to humans because it is colorless, odorless, and tasteless. It is typically produced during the incomplete combustion of fuels containing carbon—such as the charcoal chips that are normally used. Especially when ignition chimneys are operated in enclosed or inadequately ventilated spaces, there is an acute risk of carbon monoxide poisoning. This can occur, for example, when preparing a plurality of charcoal pieces for use with water pipes, which is practiced, for example, in respective indoor areas of hookah lounges.

The object of the present invention is thus to provide an ignition chimney, or an additional device for a ignition chimney, in which the risk of carbon monoxide poisoning due to exhaust gases during combustion of the (carbonaceous) fuel is substantially reduced.

The previously derived object is initially and substantially achieved with ignition chimney described in the introduction in that a catalyst for catalyzing the oxidation of carbon monoxide to carbon dioxide with oxygen is arranged above the receptacle for the fuel in such a way that the fuel exhaust gases produced in the ignited state of the fuel are at least partially guided to the catalyst or through the catalyst and at least a portion of the carbon monoxide present in the fuel exhaust gases is oxidized to carbon dioxide.

By arranging the catalyst above the receptacle for the fuel, the fuel exhaust gases containing the toxic carbon monoxide are caused to be guided to or through the catalyst and to come at least partially into contact with the catalyst, thereby effectively reducing the amount of carbon monoxide in the fuel exhaust gases. This does not have to involve active guidance of the fuel exhaust gases, for example by means of corresponding guide elements; the fuel exhaust gases can also simply be guided to the catalyst by the vertical convection flow that is formed. The advantage of such an ignition chimney is that a major problem in the use of ignition chimneys is eliminated by very simple means. If the catalyst is cleverly designed, the carbon monoxide content in the fuel exhaust gases can be eliminated for the most part by the catalytic process used.

This makes the use of ignition chimneys in closed rooms considerably safer, and in particular also reduces the requirements for corresponding ventilation and exhaust systems.

In a preferred design of the invention, it is provided that the catalyst is arranged or designed in such a way that, in the operating state, when the fuel is ignited, the oxygen required for catalyzing the oxidation of carbon monoxide to carbon dioxide is provided by ambient air. This has the advantage that oxygen does not have to be provided separately for catalyzing oxidation. Although this reduces the oxygen content in the ambient air, since this is bound during oxidation of carbon monoxide to carbon dioxide, carbon dioxide is not toxic per se, at least not in the concentrations produced here.

In a further advantageous design, it is provided that the catalyst can be flowed through, wherein, in the intended operating state with ignited fuel and catalyst flowed through by the fuel exhaust gases, the catalyst has a low flow resistance between the inflow side and the outflow side. The flow resistance should be selected such that a pressure drop between the inflow side and the outflow side of the catalyst is at most 15 Pa, preferably at most 1 Pa, preferably at most 0.5 Pa, more preferably at most 0.05 Pa. The lower the flow resistance, the easier it is for the fuel exhaust gases to pass through the catalyst, thus avoiding congestion effects on the inlet side of the catalyst. The flow resistance cannot be made arbitrarily small, since the catalyst must, of course, also provide a sufficiently large surface area in the flow of fuel exhaust gases so that the desired proportion of carbon monoxide from the fuel exhaust gases is converted to carbon dioxide by catalysis.

In another preferred design, it is provided that the catalyst is designed such that the energy released from the ignited fuel is sufficient to drive the fuel exhaust gases through the catalyst. This design has the advantage that no auxiliary device needs to be provided to drive the fuel exhaust gases through the catalyst. The gas stream is thus driven by the energy released by the ignited fuel itself. The main effect here is to cause a convection flow, so that hot and thus less dense fuel exhaust gases rise upward into the cooler and, thus, denser ambient air and automatically find their way through the catalyst, which is arranged above the receptacle for the fuel.

It has been found to be advantageous if the catalyst is formed at least in part from a coated, open-pore ceramic foam, wherein the coating is formed at least in part of metal oxides, in particular transition metals and/or noble metals. Such catalysts have been found to be very robust. In addition, they have the advantage that they can be cleaned comparatively easily, for example with a moderate flow of compressed air.

Preferably, the catalyst is arranged relative to the receptacle for the fuel in such a way that, in the operating state with ignited fuel, the energy transported to the catalyst by the ignited fuel is sufficient to achieve the catalyst temperature required for the catalysis of carbon monoxide to carbon dioxide to be effected. This design of the ignition chimney according to the invention or of the catalyst used therein is also advantageous in particular because a separate energy supply for heating the catalyst can be completely dispensed with, the catalyst thus reaches its start-up temperature solely with energy supply from the ignited fuel (thermal radiation) and by the fuel exhaust gases caused thereby (convection). The heat input here occurs, on the one hand, through the hot convective flow of the fuel exhaust gases through the catalyst, but, on the other hand, also through direct heat radiation from the ignited fuel.

Preferably, such a catalyst is selected which has a required catalyst temperature (start-up temperature) of at most 800° C., preferably of at most 400° C., preferably of at most 300° C., particularly preferably of at most 200° C. and further preferably of at most 100° C. Catalysts with a low start-up temperature have the advantage that they reach their operating temperature more quickly and thus the desired effect of catalyzing carbon monoxide into carbon dioxide is achieved more quickly. Various tests have shown that different catalysts exhibit the catalytic effect even below their specified start-up temperature, i.e., they reduce the activation energy of the desired oxidation.

In a preferred further development of the ignition chimney, it is provided that a holder for the catalyst is formed in or on the housing, in particular in the upper region of the upper combustion chamber, wherein the catalyst is held by the holder, in particular is held detachably by the holder. The holder may, for example, consist of a simple circumferential cross-piece on the inner wall of the housing, on which the catalyst rests loosely. The catalyst can then be removed for feeding and for removing fuel into and out of the upper combustion chamber.

In a further preferred design, it is provided that an opening is formed in the housing in the side region of the upper combustion chamber, via which the fuel can be introduced into the upper combustion chamber and removed from the upper combustion chamber, in particular without first removing the catalyst, in particular wherein the opening can be closed by a closure element. In this case, the catalyst need not necessarily be detachably held by the holder.

A further preferred design provides that the catalyst is part of a catalyst unit having a tube, and the catalyst is held in the tube, wherein the tube extends between a first tube opening and a second tube opening, wherein, in the assembled state of the catalyst unit, the first tube opening is arranged below the second tube opening, wherein the catalyst is held in the cross section of the tube with a holding device between the first tube opening and the second tube opening, wherein the tube is inserted into the housing in the region of the upper combustion chamber or is slipped over the housing in order to achieve the assembled state of the catalyst unit. With such a catalyst unit, it is also possible to provide ignition chimneys known from the prior art with a catalyst. It is only necessary to ensure that a corresponding mechanical adaptation is provided so that the tube can be inserted into the housing in the region of the upper combustion chamber or slipped over the housing to achieve the assembled state of the catalyst unit.

In particular, the catalyst should occupy at least 99%, especially at least 95%, preferably at least 85%, preferably at least 75% or even only at least 40% of the cross-sectional area of the tube. The larger the cross-sectional area covered by the catalyst in the tube, the lower the possible jamming effects in the flow. On the other hand, the catalyst is effective only in the area through which fuel exhaust gases flow. When designing the size of the catalyst, therefore, a tradeoff must be made between the different costs of catalysts of different sizes and the flow boundary conditions to be set.

Preferably, the holding device of the catalyst unit in the tube is designed as an at least partially circumferential collar. The collar does not have to be completely circumferential; it can also have various interruptions. In any case, it is important that the catalyst can be supported on the collar inside the tube in the assembled state on the basis of its weight.

Preferably, it is provided that flow openings are formed between the wall of the tube and the catalyst, in particular flow openings with a free cross-section. These flow openings functionally act as a bypass for bypassing the flow path through the catalyst. Since the flow openings are provided between the wall of the tube and the catalyst, i.e. outside the central flow area of the fuel exhaust gases, these flow openings are increasingly used only if the actual flow path of the fuel exhaust gases through the catalyst is blocked, for example by corresponding contamination.

Such a design of the catalyst unit is particularly well suited as a separate accessory for an ignition chimney, since it can also be used for ignition chimneys that are not yet equipped with a catalyst or a catalyst unit.

The object according to the invention is further achieved by a catalyst unit for an ignition chimney. The catalyst unit is seen here as a separate component which is prepared for use with an ignition chimney. Thus, it is a separate catalyst unit with the characteristics of the catalyst unit previously presented in connection with the described ignition chimney. Thus, it concerns a catalyst unit for an ignition chimney for carbonaceous fuel with a catalyst for catalyzing the oxidation of carbon monoxide to carbon dioxide with oxygen, wherein the ignition chimney comprises a housing, a lower combustion chamber formed in the housing for easily ignitable igniter, an upper combustion chamber formed in the housing for the carbonaceous fuel, wherein, in the ready-to-use state, the upper combustion chamber is arranged above the lower combustion chamber and the lower combustion chamber is separated from the upper combustion chamber by a gas-permeable separator, wherein the upper side of the separator faces the upper combustion chamber forming a receptacle for the fuel, wherein the separator is formed such that the igniter exhaust gases produced in the ignited state of the igniter pass through the separator and strike the fuel resting on the separator, wherein the catalyst unit comprises the catalyst and a tube and the catalyst is held in the tube, wherein the tube extends between a first tube opening and a second tube opening, wherein, in the assembled state of the catalyst unit, the first tube opening is arranged below the second tube opening, wherein the catalyst is held in the cross-section of the tube with a holding device between the first tube opening and the second tube opening, wherein, in order to achieve the assembled state of the catalyst unit, the tube can be inserted into the housing in the region of the upper combustion chamber or can be slipped over the housing. All of the features discussed above in connection with the catalyst unit of the ignition chimney are, of course, equally applicable to the aforementioned catalyst unit.

In detail, there is now a plurality of possibilities for designing and further developing the ignition chimney according to the invention and the catalyst unit according to the invention. For this, reference is made both to the patent claims subordinate to the independent claims and to the following description of preferred embodiments in conjunction with the drawing. The drawing shows

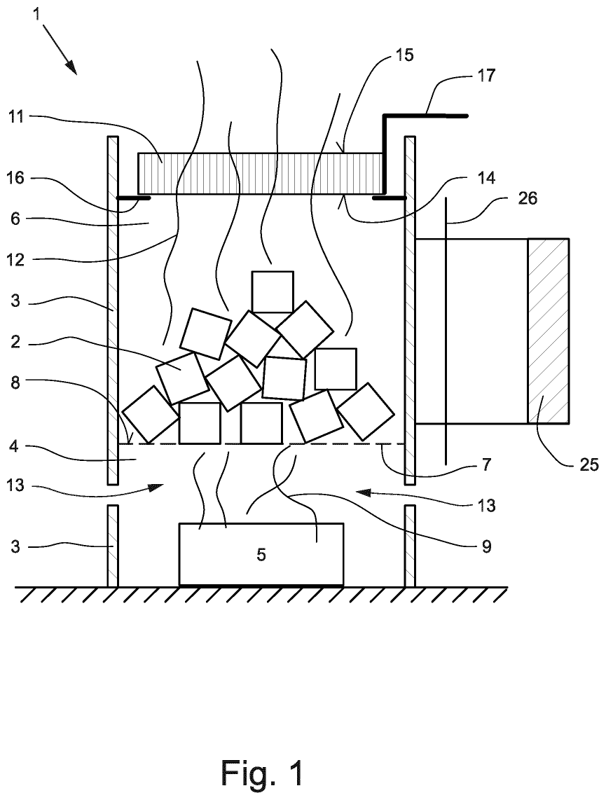

FIG. 1 schematically, an ignition chimney with catalyst unit,

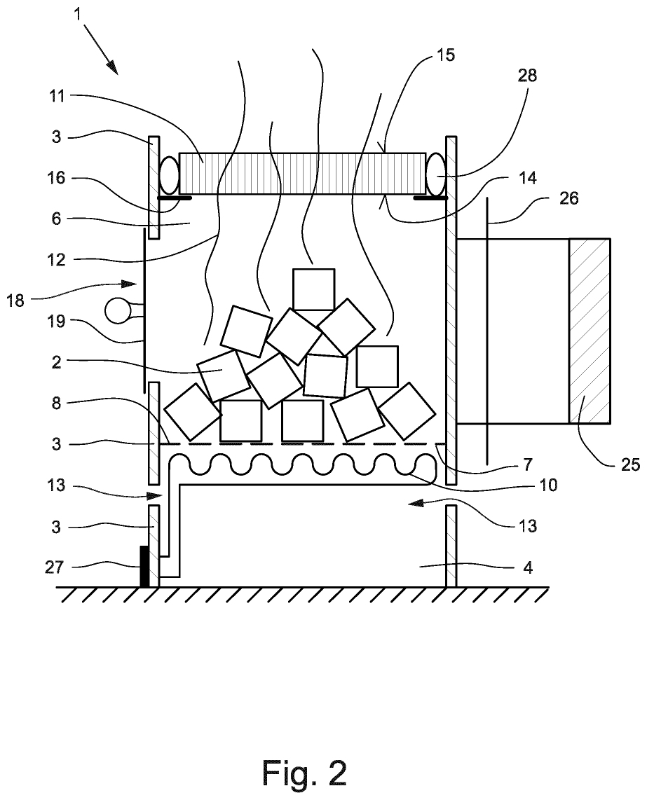

FIG. 2 an ignition chimney with a side opening in the housing in the upper combustion chamber and with a catalyst unit, and

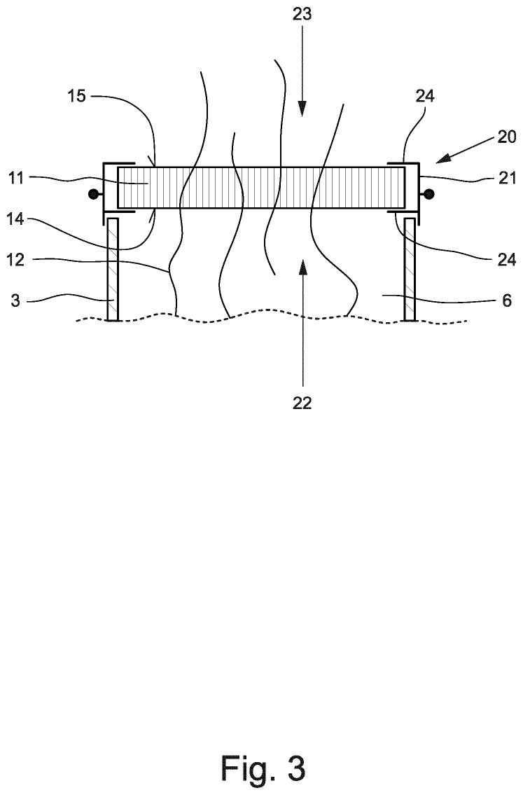

FIG. 3 schematically, a catalyst unit with a housing, which is only partially indicated, of an ignition chimney.

In each of FIGS. 1 and 2, a complete ignition chimney 1 is shown. The ignition chimney 1 serves for the simple ignition of carbonaceous fuel 2. The ignition chimney 1 has a housing 3, a lower combustion chamber 4 formed in the housing 3 for easily ignitable igniters 5 and an upper combustion chamber 6 formed in the housing 3 for the carbonaceous fuel 2. The carbonaceous fuel 2 is charcoal such as are suitable for the operation of a grill or also for the operation of a water pipe. In the ready-to-use state, the upper combustion chamber 6 is arranged above the lower combustion chamber 4, and the lower combustion chamber 4 and the upper combustion chamber 6 are separated from each other by a gas-permeable separator 7. In the present case, the gas-permeable separator 7 is a perforated sheet. The upper side 8 of the separator 7, which faces the upper combustion chamber 6, forms a receptacle for the fuel 2. The separator 7 is designed in such a way that the igniter exhaust gases 9 produced in the ignited state of the igniter 5 pass through the separator 7 and strike the fuel 2 resting on the separator 7.

FIG. 2 shows an alternative to a flammable igniter 5. Here, an electric heating element 10 provides the heat required to ignite the fuel 2 in the upper combustion chamber 3. An electrical connection element 27 is provided on the housing 3 of the ignition chimney 1 for connecting the electrical heating element 10 to an electrical power source. Thus, the lower combustion chamber 4 does not necessarily have to accommodate a igniter 5, it can be any suitable heat source.

A handle 25 with a heat shield 26 is provided on the side of the housing for handling the ignition chimney 1.

Above the receptacle for the fuel 2, a catalyst 11 is provided for catalyzing the oxidation of carbon monoxide to carbon dioxide with oxygen. Accordingly, the catalyst 11 is arranged such that the fuel exhaust gases 12 produced when the fuel 2 is ignited are at least partially directed to the catalyst 11 or through the catalyst 11 and at least a portion of the carbon monoxide present in the fuel exhaust gases 12 is oxidized to carbon dioxide.

Carbon monoxide gas is formed during the primarily incomplete combustion of the carbonaceous fuel 2. Carbon monoxide is toxic to humans and causes asphyxiation above a certain breathing air concentration. The carbon monoxide is primarily a component of the fuel exhaust gas 12 produced when the fuel 2 is ignited. The emission of carbon monoxide is a massive problem, especially when ignition chimneys 1 are operated in enclosed spaces. It is not uncommon for inadmissible concentrations of carbon monoxide to be reached here, because insufficient provision has been made for adequate ventilation of the premises.

To solve this problem, a catalyst 11 is arranged above the receptacle for the fuel 2—and thus above the fuel 2. The catalyst 11 serves to catalyze the oxidation of carbon monoxide to carbon dioxide with oxygen. The catalyst 11 is arranged such that the fuel exhaust gases 12 produced in the ignited state of the fuel 2 are at least partially passed through the catalyst 11, and at least a portion of the carbon monoxide present in the fuel exhaust gases 12 is oxidized to carbon dioxide. In the following, therefore, the embodiment of the catalyst 11 or also of a separate catalyst unit 20, which is shown in FIG. 3 is essentially of concern.

Common to all embodiments is that the catalyst 11 is arranged or configured in such a way that, in the operating state, i.e. when the fuel 2 is ignited, the oxygen required for catalyzing the oxidation of carbon monoxide to carbon dioxide is provided by the ambient air 13. As a result, a separate oxygen supply for the catalyst 11 can be dispensed with, and the catalyst 11 is thus operable independently of a separate oxygen supply. For this, design measures are taken in part, which will be described further below. In the figures, the flow paths of ambient air 13 are partially indicated.

In all embodiments, the catalyst 11 can be flowed through by a gas, wherein, in the intended operating state with ignited fuel 2 and catalyst 11 flowed through by the fuel exhaust gases 12, the catalyst 11 has a very low flow resistance between the inflow side 14 and the outflow side 15. The flow resistance is set here such that, in the operating state and in flow equilibrium, at most a pressure difference of at most 0.5 Pa occurs between the inflow side 14 and the outflow side 15 of the catalyst 11.

All the embodiments shown also have in common that the catalyst 11 is designed in such a way that (under relatively normal ambient conditions) the energy released by the ignited fuel 2 is sufficient to drive the fuel exhaust gases 12 through the catalyst 11. This measure also recognizably contributes the catalyst 11 being able to be operated in a self-sufficient manner.

In the illustrated embodiments, the catalyst 11 is formed from a coated, open-pored ceramic foam. To achieve the catalytic effect, the ceramic foam is coated with metal oxides, in this case transition metals and noble metals. In the illustrated embodiments, the catalyst 11 is arranged relative to the receptacle for the fuel 2, and thus also relative to the fuel 2 itself, in such a way that, in the operating state when the fuel 2 is ignited or when the electric heating device 10 is active, the energy transported to the catalyst 11 by the ignited fuel 2 or the energy transported to the catalyst 11 by the electric heating device 10 is sufficient to achieve the catalyst temperature required for the catalysis of carbon monoxide to carbon dioxide to be effected. In the illustrated embodiments, the catalyst 11 has a required catalyst temperature of 350° C. However, experiments have shown that the catalytic effect promotes the oxidation of carbon monoxide with atmospheric oxygen to carbon dioxide even at considerably lower temperatures starting above 150° C.

As a result, the catalyst 11 shown in the figures can be operated completely autonomously. The supply of separate oxygen is not required (the atmospheric oxygen present in the ambient air 13 is sufficient), the catalyst 11 does not need to be force-ventilated (the convective air flow or flow of fuel exhaust gases 12 caused by the combustion of the fuel 2 is sufficient), and the catalyst 11 used does not require any energy supply other than that which it receives anyway due to its arrangement above the ignited fuel 2. The catalyst 11 can therefore, for example, also simply be placed on an already existing conventional ignition chimney, i.e. an ignition chimney which has not yet been equipped with a catalyst 11, so that the problem of the emission of carbon monoxide can be remedied very quickly and without any conversion measures.

In FIGS. 1 and 2, it is shown that a holder 16 for the catalyst 11 is formed in or on the housing 3, namely in the upper region of the upper combustion chamber 6, wherein the catalyst 11 is held by the holder 16, in the present case releasably held by the holder 16. In FIG. 1, the catalyst 11 rests loosely on the holder 16. The catalyst 11 can be easily handled by means of a mounting bracket 17, i.e. removed from the holder 16 and placed on the holder 16. In FIG. 2, the catalyst 11 is additionally held in the housing 3 of the ignition chimney 1 by a fire-proof chimney band 28.

FIG. 2 further shows that an opening 18 is formed in the housing 3 in the side region of the upper combustion chamber 6, through which the fuel 2 can be introduced into the upper combustion chamber 6 and removed from the upper combustion chamber 6; for this, the catalyst 11 does not have to be removed beforehand. The opening 18 can be closed by a closing element 19 in the form of a flap. This has the advantage that the catalyst 11 does not have to be removable from the housing 3 of the ignition chimney 1.

The upper part of a ignition chimney 1 is shown in FIG. 3, wherein the catalyst 11 is part of a catalyst unit 20 with a tube 21 and the catalyst 11 is held in the tube 21, wherein the tube 21 extends between a first tube opening 22 and a second tube opening 23, wherein, in the assembled state of the catalyst unit 20, the first tube opening 22 is arranged below the second tube opening 23, wherein the catalyst 11 is held in the cross-section of the tube 21 with a holding device 24 between the first tube opening 22 and the second tube opening 23, wherein the tube 21 is slipped over the housing 3 in the region of the upper combustion chamber 6 to achieve the assembled state of the catalyst unit 20.

In the illustrated embodiment, the catalyst 11 occupies over 90% of the cross-section of the tube 21.

In FIG. 3, the holding device 24 of the catalyst unit 21 is formed in the tube 21 as an at least partially circumferential collar, wherein the collar has interruptions. The catalyst 11 is supported on the collar or collar elements in the assembled state on the basis of its weight, and further the catalyst 11 is positively held in the holding device 24 so that it is securely held in the holding device 24 and cannot fall out of it even if the catalyst unit 20 is removed from the housing 3 of the ignition chimney 1 and moved.

### REFERENCE NUMBERS

1 Ignition chimney
2 Fuel
3 Housing
4 Lower combustion chamber
5 Igniter
6 Upper combustion chamber
7 Separator
8 Upper side of separator
9 Igniter exhaust
10 Electric heating element
11 Catalyst
12 Fuel exhaust gases
13 Ambient air
14 Inlet side of the catalyst
15 Outlet side of the catalyst
16 Holder
17 Mounting bracket
18 Opening
19 Closure element
20 Catalyst unit
21 Tube
22 First tube opening
23 Second tube opening
24 Holding device
25 Handle
26 Heat shield
27 Electrical connection element
28 Fire-proof chimney band

1. Ignition chimney (1) for carbonaceous fuel (2), with a housing (3), a lower combustion chamber (4) formed in the housing (3) for easily ignitable igniter (5), with an upper combustion chamber (6) formed in the housing (3) for the carbonaceous fuel (2), wherein, in the ready-for-operation state, the upper combustion chamber (6) is arranged above the lower combustion chamber (4), and the lower combustion chamber (4) and the upper combustion chamber (6) are separated from one another by a gas-permeable separator (7), wherein the upper side (8) of the separator (7), which faces the upper combustion chamber (6), forms a receptacle for the fuel (2), wherein the separator (7) is designed in such a way that the igniter exhaust gases (9) produced in the ignited state of the igniter (5) pass through the separator (7) and strike the fuel (2) resting on the separator (7),
characterized in
that a catalyst (11) for catalyzing the oxidation of carbon monoxide to carbon dioxide with oxygen is arranged above the receptacle for the fuel (2) in such a way that the fuel exhaust gases (12) produced in the ignited state of the fuel (2) are directed at least partially to the catalyst (11) or through the catalyst (11) and at least some of the carbon monoxide present in the fuel exhaust gases (12) is oxidized to carbon dioxide.

2. Ignition chimney (1) according to claim 1, characterized in that the catalyst (11) is arranged or designed in such a way that, in the operating state, when the fuel (2) is ignited, the oxygen required to catalyze the oxidation of carbon monoxide to carbon dioxide is provided by ambient air (13).

3. Ignition chimney (1) according to claim 1 or 2, characterized in that the catalyst (11) can be flowed through, wherein, in the intended operating state, where ignited fuel (2) and catalyst (11) are flowed through by the fuel exhaust gases (12), the catalyst (11) has such a low flow resistance between the inflow side (14) and the outflow side (15), that a pressure drop of at most 15 Pa, preferably of at most 1 Pa, preferably of at most 0.5 Pa, particularly preferably of at most 0.05 Pa, occurs.

4. Ignition chimney (1) according to any one of claims 1 to 3, characterized in that the catalyst (11) is designed such that the energy released by the ignited fuel (2) is sufficient to drive the fuel exhaust gases (12) through the catalyst (11).

5. Ignition chimney (1) according to any one of claims 1 to 4, characterized in that the catalyst (11) is formed at least partially from a coated, open-pored ceramic foam, wherein the coating is formed at least partially from metal oxides, in particular from transition metals and/or noble metals.

6. Ignition chimney (1) according to any one of claims 1 to 5, characterized in that the catalyst (11) is arranged relative to the receptacle for the fuel (2) in such a way that, in the operating state with ignited fuel (2), the energy transported by the ignited fuel (2) to the catalyst (11) is sufficient to achieve the catalyst temperature required for bringing about catalysis of carbon monoxide to carbon dioxide.

7. Ignition chimney (1) according to claim 6, characterized in that the catalyst (11) has a required catalyst temperature of at most 800° C., in particular of at most 400° C., in particular of at most 300° C., in particular of at most 200° C., preferably of at most 100° C.

8. Ignition chimney (1) according to any one of claims 1 to 7, characterized in that a holder (16) for the catalyst (11) is formed in or on the housing (3), in particular in the upper region of the upper combustion chamber (6), wherein the catalyst (11) is held by the holder (16), in particular is held detachably by the holder (16).

9. Ignition chimney (1) according to any one of claims 1 to 8, characterized in that an opening (18) is formed in the housing (3) in the side region of the upper combustion chamber (6), via which opening the fuel (2) can be introduced into the upper combustion chamber (6) and can be removed from the upper combustion chamber (6), in particular without first removing the catalyst (11), in particular wherein it is possible to close the opening (18) with a closure element (19).

10. Ignition chimney (1) according to any one of claims 1 to 7, characterized in that the catalyst (11) is a component of a catalyst unit (20) with a tube (21) and the catalyst (11) is held in the tube (21), wherein the tube (21) extends between a first tube opening (22) and a second tube opening (23), wherein, in the assembled state of the catalyst unit (20), the first tube opening (22) is arranged below the second tube opening (23), wherein the catalyst (11) is held in the cross section of the tube (21) with a holding device (24) between the first tube opening (22) and the second tube opening (23), wherein, in order to achieve the assembled state of the catalyst unit (20), the tube (21) is inserted into the housing (3) in the region of the upper combustion chamber (6) or is slipped over the housing (3).

11. Ignition chimney (1) according to claim 10, characterized in that the catalyst (11) occupies at least 99%, preferably at least 95%, in particular at least 85%, preferably at least 75% of the cross-section of the tube (21).

12. Ignition chimney (1) according to claim 10 or 11, characterized in that the holding device (24) of the catalyst unit (20) in the tube (21) is designed as an at least partially circumferential collar, in particular wherein the collar has interruptions on which the catalyst (11) is supported in the assembled state due to its weight force.

13. Catalyst unit (20) for an ignition chimney (1) for carbonaceous fuel (2) with a catalyst (11) for catalyzing the oxidation of carbon monoxide to carbon dioxide with oxygen, wherein the ignition chimney (1) has a housing (3), a lower combustion chamber (4) formed in the housing (3) for easily ignitable igniter (5), an upper combustion chamber (6) formed in the housing (3) for the carbonaceous fuel (2), wherein, in the ready-for-operation state, the upper combustion chamber (6) is arranged above the lower combustion chamber (4) and the lower combustion chamber (4) is separated from the upper combustion chamber (6) by a gas-permeable separator (7), wherein the upper side (8) of the separator (7), which faces the upper combustion chamber (6), forms a receptacle for the fuel (2), wherein the separator (7) is formed in such a manner that the igniter exhaust gases (9) produced in the ignited state of the igniter (5) pass through the separator (7) and strike the fuel (2) resting on the separator (7), wherein the catalyst unit (20) comprises the catalyst (11) and a tube (21) and the catalyst (11) is held in the tube (21), wherein the tube (21) extends between a first tube opening (22) and a second tube opening (23) wherein, in the mounting state of the catalyst unit (20), the first tube opening (22) is located below the second tube opening (23), wherein the catalyst (11) is held in the cross-section of the tube (21) with a holding device (24) between the first tube opening (22) and the second tube opening (23), wherein, in order to achieve the assembled state of the catalyst unit (11), the tube (21) can be inserted into the housing (3) in the region of the upper combustion chamber (6) or can be slipped over the housing (3).

14. Catalyst unit (20) according to claim 13, characterized by the features of at least one characterizing portion of claims 1 to 12.
